(19) United States
(12) Patent Application Publication
(10) Pub. No.: US 2011/0234625 A1
(43) Pub. Date: Sep. 29, 2011

(54) DISPLAY DEVICE AND METHOD FOR DRIVING SAME

(75) Inventors: Kentaro Irie, Osaka (JP); Masae Kawabata, Osaka (JP); Hiroto Suzuki, Osaka (JP); Fumikazu Shimoshikiryoh, Osaka (JP)

(73) Assignee: SHARP KABUSHIKI KAISHA, OSAKA (JP)

(21) Appl. No.: 12/998,833

(22) PCT Filed: Sep. 2, 2009
(86) PCT No.: PCT/JP2009/065341

§ 371 Date: Jun. 8, 2011

(30) Foreign Application Priority Data
Jan. 30, 2009 (JP) 2009-040790

(51) Int. Cl. G09G 5/02; G09G 5/10

(52) U.S. Cl. 345/601; 345/600; 345/690

(57) ABSTRACT

A display device carries out an overshoot process on gray scale data of a target frame, the gray scale data being to be converted into a data signal, the overshoot process converting the gray scale data so that the gray scale data includes an overshoot amount in accordance with at least the gray scale data of a predetermined frame preceding the target frame and the gray scale data of the target frame, and further carrying out gray scale correction on overshoot-processed gray scale data obtained by carrying out the overshoot process on the gray scale data of the target frame, the gray scale correction being carried out by use of a correction amount corresponding to each of positions of respective columns to each of which the data signal is to be supplied, the respective columns being on a display panel.

### TECHNICAL FIELD

The present invention relates to a technique for improving an in-plane distribution of display quality in a display panel.

### BACKGROUND ART

In an active matrix liquid crystal display device adopting TFTs as selection elements of respective picture elements, it is well known that a feed through phenomenon occurs (See Non-Patent Document 1, for example). The following briefly explains such a feed through phenomenon.

FIG. 5 is an equivalent circuit of one picture element. One picture element PIX is provided so as to correspond to an intersection of a gate bus line GL and a source bus line SL. The picture element PIX includes a TFT 101, a liquid crystal capacitance Clc, and a storage capacitance Cs. In addition, the picture PIX, in general, includes a parasitic capacitance such as a capacitance Cgd or the like formed between a picture element electrode 102 and the gate bus line GL. A gate of the TFT 101 is connected to the gate bus line GL; a source of the TFT 101 is connected to the source bus line SL; and a drain of the TFT 101 is connected to the picture element electrode 102. The liquid crystal capacitance Clc is formed in a configuration in which a liquid crystal layer is provided between the picture element electrode 102 and a common electrode to which a voltage Vcom is applied. The storage capacitance Cs is formed in a configuration in which a dielectric layer is provided between (i) a storage capacitance bus line to which a voltage Vcs is applied and (ii) the picture element electrode 102 or an electrode that is connected to the picture element electrode 102. The voltage Vcs is equal to, for example, the voltage Vcom, but may also be a voltage of other value.

As shown in FIG. 6, to the gate bus line GL, a selection signal Vg is outputted from a gate driver. The selection signal Vg includes two value levels that include a gate high voltage Vgh and a gate low voltage Vgl. A gate pulse of the selection signal Vg has a peak-to-peak voltage expressed by Vgp−p=Vgh−Vgl. Further, to the source bus line SL, a positive-polarity data signal (hereinafter, referred to as a positive data signal) Vsp and a negative-polarity data signal (hereinafter, referred to as a negative data signal) Vsn are outputted from a source driver while these signals are switched to each other by AC drive.

FIG. 6 focuses on one picture element PIX and shows a state in which a positive data signal Vsp is written, as a data signal Vs, to the picture element electrode 102 in one frame period TF1, and in a next frame period TF2, a negative data signal Vsn is written to the picture element 102.

Prior to the frame period TF1, a potential Vdn has been written to the picture element electrode 102. In the frame period TF1, the gate pulse of the selection signal Vg is applied to the gate of the TFT 101 and the TFT 101 is turned ON. Then, a potential is written toward the Vsp of the data signal Vsp to the picture element electrode 102. As a result, the liquid crystal capacitance Clc and the storage capacitance Cs are charged. Then, when the gate pulse falls, the TFT 101 is turned OFF and the writing to the picture element electrode 102 ends. At this time, the gate pulse has an abrupt change from the gate high voltage Vgh to the gate low voltage Vgl. Accordingly, due to the feed through phenomenon via the capacitance Cgd that is the parasitic capacitance between the picture element electrode 102 and the gate bus line GL, a potential of the picture element electrode 102 decreases by a voltage ΔVd and a potential of the picture element electrode 102 becomes Vdp that is lower than a potential of the data signal Vsp. This voltage ΔVd is called a feed through voltage. The voltage ΔVd is expressed as follows:

$$\begin{matrix}Δ Vd = ( Cgd / Cpix ) \cdot Vgp - p \\ = ( Cgd / Cpix ) \cdot ( Vgh - Vgl ) ,\end{matrix} \qquad ( 1 )$$

where Cpix is a total capacitance of a picture element that is a sum of the liquid crystal capacitance Clc, the storage capacitance Cs, and the parasitic capacitance such as the capacitance Cgd or the like. In a case where only the capacitance Cgd is taken into consideration as a parasitic capacitance in FIG. 5, Cpix=Clc+Cs+Cgd.

Prior to the frame period TF2, a potential Vdp has been written to the picture element electrode 102. In the frame period TF2, the gate pulse of the selection signal Vg is applied to the gate of the TFT 101 and the TFT 101 is turned ON. Then, a potential is written toward the potential Vsn of the data signal Vsn to the picture element electrode 102. As a result, the liquid crystal capacitance Clc and the storage capacitance Cs are charged. Then, as in the frame period TF1, when the gate pulse falls, a potential of the picture element electrode 102 decreases by a voltage ΔVd due to the feed through phenomenon via the capacitance Cgd and a potential of the picture element electrode 102 becomes Vdn that is lower than a potential of the data signal Vsn.

In the liquid crystal display panel, due to the occurrence of this feed through phenomenon, in a case where the voltage Vcom is set to the center of a voltage range between a voltage range of the positive data signal Vsp and a voltage range of the negative data signal Vsn, the voltage Vcom becomes a value that is shifted to a higher value by ΔVd from the center value of a voltage range between a positive range and a negative range of the voltages held after writing to the picture element electrode 102. Accordingly, in each picture element PIX, positive-polarity and negative-polarity voltages across the liquid crystal layer have different effective values. This causes deterioration in display quality and deterioration in liquid crystals.

In order to solve this problem, it is possible to take a method according to which, by correcting gray scale data to be supplied to the source driver by a change amount of ΔVd in advance, an influence of the feed through phenomenon is compensated. That is, a voltage of the data signal supplied to the picture element PIX decreases by ΔVd after completion of writing to the picture element electrode 102. This means that, substantially, the source driver supplies, to the picture element PIX, data signal that is lower by ΔVd than a target value. Therefore, the gray scale data to be supplied to a display controller is corrected to gray scale data corresponding to a data signal whose voltage is shifted so as to be increased by the voltage ΔVd. Then, thus corrected gray scale data is supplied to the source driver.

However, on the display panel, the gate bus line GL has a resistance component and a capacitance component as distributed constants. Accordingly, the gate pulse outputted from the gate driver to the gate bus line GL reaches, with a propagation delay, the gate of the TFT 101 of each picture element PIX. As a result, a waveform of the gate pulse receives a greater influence of the delay at a position farther from a position at which the gate driver outputs the gate pulse. For example, as shown in FIG. 7, in a case where a gate pulse VG(j) of the j-th gate bus line GL is generated by the gate driver and a waveform of this gate pulse VG (j) is an ideal square pulse, a delay of a gate pulse Vg (1, j) that reaches a picture element PIX of a first column of the j-th line is small whereas a delay of a gate pulse Vg (N, j) that reaches a picture element PIX of an Nth column of the j-th line is large.

A threshold voltage VT of the TFT 101 is present as a potential at some midpoint in a fall of the gate pulse. Accordingly, if the gate pulse falls slowly due to the delay, a smaller change amount SyN per time unit in the fall of the gate pulse shown in FIG. 7 results in a longer transition time that the TFT 101 takes for transition to an OFF state. In addition, in such a case, a waveform of the gate pulse has a gentler slope, before the gate pulse decays to a gate low level after the TFT 101 is turned OFF. As a result, a feed through regarding the capacitance Cgd becomes smaller. This makes ΔVd smaller. This is inconsistent with the expression (1) that can be derived from an electrostatic solution that employs only the law of conservation of charge.

In other words, a change amount SyN is smaller when a distance from a position of the output of the gate driver to the gate is larger. Accordingly, the voltage ΔVd has a distribution such that the voltage ΔVd is smaller in a picture element PIX that has a larger distance from the position of the output of the gate driver on the display panel. In FIG. 7, in a picture element PIX to which a gate pulse Vg (1, j) with a small delay is applied, a potential of the picture element electrode 102 abruptly changes and a decrease of ΔVd(1) in potential occurs. Meanwhile, in a picture element PIX to which a gate pulse Vg (N, j) with a large delay is applied, a potential of the picture element electrode 102 slowly changes and a decrease of ΔVd(N) in potential occurs. Here, ΔVd(1)>ΔVd(N).

For the above reason, in a case where all gray scale data that is to be supplied to the source driver is uniformly corrected, a feed through phenomenon cannot be cancelled out uniformly within a plane of the panel. As a result, unevenness in display quality occurs.

In order to solve this problem, for compensating the feed through phenomenon by correcting the gray scale data, a certain distribution in correction amount of the gray scale data is provided within the plane of the panel.

For example, in the display panel as shown in (a) of FIG. 8, the gate pulse is supplied to each gate bus line from both sides of the panel. Accordingly, in a case where a position on the display panel is expressed by using a position of a column, the closer to a column at an end section A of the panel a picture element PIX is, the larger a voltage ΔVd of this picture element PIX becomes. Meanwhile, in such a case, the closer to a column at a center section C of the panel a picture element PIX is, the smaller a voltage ΔVd of this picture element PIX becomes. Accordingly, as shown in (b) of FIG. 8, in a case where a positive data signal Vsp or negative data signal Vsn corresponding to certain gray scale data is uniformly set as indicated by a dotted line within the plane of the panel (i.e., in a left-right direction of the panel), both a positive picture element electrode potential Vdp and a negative picture electrode potential Vdn of a picture element electrode potential Vd after the occurrence of the feed through phenomenon shows a distribution in a curved form, as shown by a solid line, which is convex upward and has a top at the column at the center section C of the panel. In this case, the voltage across the liquid crystal layer in accordance with positive gray scale data is the largest at the center section C of the panel and gradually decreases towards end sections A of the panel from the center section C through intermediate sections B of the panel. Meanwhile, the voltage across the liquid crystal layer in accordance with negative gray scale data is the smallest at the center section C and gradually increases towards the end sections A from the center section C through the intermediate sections B of the panel. Accordingly, as indicated by the dotted line in (c) of FIG. 8, gray scale data of picture elements are corrected so that, before the gray scale data is supplied to the display driver, the distribution of the voltage ΔVd is compensated in advance, that is, the gray scale data has a distribution in which data signal voltages Vdp and Vdn are higher at positions closer to the end sections A of the panel. This makes the picture element electrode potentials Vdp and Vdn after the occurrence of the feed through phenomenon be uniform, as indicated by the solid line, within the panel plane.

In the correction of the gray scale data, now, a case where gray scale levels closer to a normally black or white level are set to be on a lower gray scale level side is considered. In this case, as show in FIG. 9, positive input gray scale data is corrected so that: value of gray scale data to be supplied to a picture element PIX at the center section C of the panel is increased only by a small number of gray scale levels; and a value of gray scale data is increased by a larger number of gray scale levels as a position of a picture element PIX to which the gray scale data is supplied approaches either of the end sections A from the center section C of the panel. Meanwhile, negative input gray scale data is corrected so that: a value of gray scale data to be supplied to a picture element PIX at the center section C of the panel is decreased only by a small number of gray scale levels; and a value of gray scale data is decreased by a larger number of gray scale levels as a position of a picture element PIX to which the gray scale data is supplied approaches either of the end sections A from the center section C of the panel.

In this way, in a case where the gray scale data is corrected so that the in-plane distribution of the voltage ΔVd is compensated, potentials are written to the picture elements PIX in accordance with data signals corresponding to corrected gray scale data. Therefore, even in a case where a potential of the picture element electrode 102 decreases by the voltage ΔVd after the writing, it is possible to make the positive data signal and the negative data signal uniformly have effective values equal to each other in a plane while the common electrode potential Vcom is not changed.

### CITATION LIST

### Patent Literature

### Patent Literature 1

Japanese Patent Application Publication, Tokukaihei, No. 7-134572 A (published on May 23, 1995)

### Patent Literature 2

Japanese Patent Application Publication, Tokukai, No. 2002-251170 A (published on Sep. 6, 2002)

### Patent Literature 3

Japanese Patent Application Publication, Tokukai, No. 2002-123209 A (published on Apr. 26, 2002)

### Non-Patent Literature

### Non-Patent Literature 1

Hori, Hiroo, and Koji Suzuki, eds. “Series Advanced Display Technologies 2—Color Liquid Crystal Display”. Kyoritsu Shuppan Col, Ltd. 1^{st} Ed. Jun. 25, 2001. pp 247-248.

### SUMMARY OF INVENTION

### Technical Problem

Correction of an amount equivalent to a voltage ΔVd described above is carried out inside a display controller. A correction section for carrying out the correction stores, in a ROM, correction amounts as shown in, for example, FIG. 9, in the form of a lookup table. With reference to this lookup table, correction is carried out on inputted gray scale data by use of a correction amount corresponding to a position of a column to which a picture element to be supplied with the gray scale data belongs. However, when overshoot drive is to be further carried out in the display device, an overshoot amount does not become an appropriate amount if a process (hereinafter, referred to as an overshoot process) for generating gray scale data to which an overshoot amount is added, is carried out on gray scale data whose voltage ΔVd is compensated.

The overshoot drive is a drive method for performing a data conversion process on gray scale data that is to be converted into a signal data of a target frame for improving a response speed of liquid crystal. The data conversion process causes the gray scale data to include an overshoot amount in accordance with at least the gray scale data of a predetermined frame preceding the target frame and the gray scale data of the target frame.

In the above overshoot drive, the overshoot amount is determined for each gray scale data based on various design concepts, for example, in consideration of display data of a preceding frame. Therefore, the overshoot amount generally differs for different gray scale data. In the display controller, an overshoot setting section carries out the overshoot process with reference to a lookup table as shown in, for example, FIG. 10. In this lookup table, information on the overshoot amount is stored. The example of FIG. 10 stores gray scale data that is obtained by increasing, by an overshoot amount for an overshooting period, each gray scale data to be used for (N+1)th frame display, in consideration of gray scale data used for Nth frame display. The overshoot setting section reads in gray scale data corresponding to each image data used for the (N+1)th frame display so as to set the overshoot amount.

This overshoot drive increases a speed of charging a liquid crystal capacitance that is charged in accordance with a time constant. This shortens a time up to a point at which a picture element electrode potential reaches an ultimate supply potential of a data signal. Consequently, a response speed of liquid crystals is improved, which means that high performance display of a moving image becomes possible. Further, the overshoot drive can shorten a re-charging period at reversal of a polarity of a data signal, for example, from a positive polarity to a negative polarity in AC drive. Accordingly, the display device that normally carries out AC drive can generally receive the benefit of shortening a period of charging by the overshoot drive.

However, the compensation of the voltage ΔVd is for preventing the occurrence of a change in a voltage itself across a liquid crystal layer, in other words, for preventing the occurrence of a change in an effective value of the voltage across the liquid crystal layer. Accordingly, it is not possible to determine the overshoot amount for a potential of a data signal corresponding to gray scale data that is corrected for compensation of the voltage ΔVd, according to the same basis as that for a potential of a data signal corresponding to gray scale data that is not corrected. In other words, because the voltage across the liquid crystal layer is a difference between the picture element electrode potential and a common electrode potential Vcom, the overshoot amount that determines the speed of charging the liquid crystal capacitance should primarily be set for the voltage across the liquid crystal layer rather than the picture element electrode potential.

Therefore, in a case where the overshoot amount is to be added to gray scale data to which correction with respect to the voltage ΔVd is carried out, an overshoot amount corresponding to a potential of a data signal corresponding to corrected gray scale data is inevitably given. As a result, the overshoot amount deviates from an overshoot amount that is appropriate for an actual writing potential after the occurrence of a feed through phenomenon in a picture element.

The following explains this with reference to FIG. 11.

Now, the following case is considered. That is, in a case where the overshoot process is carried out while no compensation of the voltage ΔVd is carried out. For example, as shown in (a) of FIG. 11, gray scale data “176” for an overshoot period is generated in such a case. The gray scale data “176” is obtained in the overshoot process (in (a) of FIG. 11, shown as an OS process) by adding an overshoot amount “64” to gray scale data “112” whose effective value of the voltage across the liquid crystal layer over one frame is 2.85 V. In this case, a substantial effective value of a voltage across the liquid crystal layer over one frame is considered. This substantial effective value is obtained by using, instead of an actual picture element electrode potential, a potential itself of a data signal corresponding to gray scale data as a picture element electrode potential in a period where an operation for writing in a data signal is carried out. Then, it is found that the substantial effective value becomes 3.79V and addition of the overshoot amount boosts the substantial effective value by 0.94 V.

Meanwhile, in a case where both the compensation of the voltage ΔVd and the overshoot process are carried out, for example, as shown in (b) of FIG. 11, with respect to the gray scale data “112” whose effective value of a voltage across the liquid crystal layer over one frame is 2.85 V, compensation of the voltage ΔVd is carried out. This compensation is carried out with reference to panel end sections A shown in FIG. 9 as an example. As a result, correction is carried out so that positive gray scale data becomes “128” and negative gray scale data becomes “96”. As a result of this compensation of the voltage ΔVd, the above effective value stays at 2.85 V. Then, in a case where an overshoot process is further carried out on the gray scale data whose voltage ΔVd is compensated, for example, gray scale data “188” is generated from the gray scale data “128” and gray scale data “158” is generated from the gray scale data “96”. The gray scale data “188” boosts by 1.13 V the substantial effective value to 3.98V and the gray scale data “158” boosts by 0.69 V the substantial effective value to 3.54 V.

Accordingly, in a case where an overshoot drive is carried out after the correction of the voltage Vd with respect to gray scale data, an effect of overshooting differs from that in a case where the overshoot process is carried out without correction of the voltage Vd. In addition, effects of overshooting become different between positive gray scale data and negative gray scale data.

As described above, in a conventional display device, there has been no method for carrying out an appropriate overshoot process as well as compensation of a feed through voltage.

The present invention is attained in view of the above conventional problem. An object of the present invention is to attain a display device that is capable of performing, with respect to each gray scale data to be converted into a data signal, an appropriate overshoot process as well as gray scale correction, such as correction of a feed through voltage, in accordance with column positions of a liquid crystal panel to be supplied with gray scale data, and a method for driving the display device.

### Solution to Problem

In order to solve the above problems, a display device of the present invention (i) carries out an overshoot process on gray scale data of a target frame, the gray scale data being to be converted into a data signal, the overshoot process converting the gray scale data so that the gray scale data includes an overshoot amount in accordance with at least the gray scale data of a predetermined frame preceding the target frame and the gray scale data of the target frame, and (ii) further carries out gray scale correction on overshoot-processed gray scale data obtained by carrying out the overshoot process on the gray scale data of the target frame, the gray scale correction being carried out by use of a correction amount corresponding to each of positions of respective columns to each of which the data signal is to be supplied, the respective columns being on a display panel.

According to the above invention, even when both an overshoot process and gray scale correction of gray scale data are carried out in which gray scale correction a correction amount has an in-plane distribution corresponding to each column position on a display panel to which a data signal is to be supplied, the overshoot process is carried out on original gray scale data of the target frame. Further, the gray scale correction is carried out on overshoot-processed gray scale data obtained by carrying out the overshoot process on the gray scale data of a target frame. Accordingly, an overshoot amount can be set according to a conventional basis. Further, because the correction amount of the gray scale correction corresponds to each column position and can be set regardless of the overshoot amount, an substantial effective value of a voltage applied to a display element can be easily made equal to an substantial effective value in a case where the overshoot process is carried out without carrying out the gray scale correction.

This makes it possible to attain a display device that can carry out an appropriate overshoot process in addition to gray scale correction, such as compensation of a feed through voltage, on each gray scale data to be converted into a data signal. The gray scale correction is carried out in accordance with each column position of a display panel to which the data signal is to be supplied.

In order to solve the above problems, the display device of the present invention is configured such that: the correction amount corresponds to a magnitude of a feed-through voltage corresponding to each of the positions of the respective columns.

According to the above invention, in a case where the gray scale correction is a process for compensating an in-plane distribution of feed through voltage, an appropriate overshoot process can be carried out.

In order to solve the above problems, the display device of the present invention is configured such that: a polarity of a data signal to be supplied to each picture element is reversed every one frame.

According to the above invention, when data of a picture element is rewritten, a polarity of a data signal is reversed. However, because an appropriate overshoot process is carried out on the gray scale data, a response speed of liquid crystals can be appropriately improved.

In order to solve the above problems, the display device of the present invention is configured such that the gray scale data to be converted into the data signal is gray scale data to be supplied to a display driver.

According to the above invention, even in a case where a display driver does not have a function to carry out gray scale correction, it is possible to carry out gray scale correction in a circuit of a preceding stage such as a display controller.

In order to solve the above problems, the display device of the present invention is configured such that a gate pulse is supplied to each gate bus line from each of both ends of the each gate bus line.

According to the above invention, a gate pulse is supplied from each of both sides of each gate bus line. Accordingly, there occurs a decrease in unevenness of the gate pulse delay distribution. This achieves a decrease in unevenness of an in-plane distribution of the gray scale correction amount for correcting the in-plane distribution of the voltage ΔVd. Therefore, it becomes possible to carry out compensation of a feed through phenomenon while keeping a wide reproduction range for the overshoot-processed gray scale data.

In order to solve the above problems, the display device of the present invention is configured such that a gate pulse is supplied to each gate bus line from one predetermined end of the each gate bus line.

According to the above invention, though there occurs an in-plane distribution with large unevenness of the feed-through voltage in each gate bus line, an overshoot process can appropriately be carried out without receiving an influence of the in-plane distribution. Accordingly, the above invention provides a significant effect such that no change occurs in an effect of the overshoot process from an effect in a case where the overshoot process is carried out without carrying out the gray scale correction.

In order to solve the above problems, the display device of the present invention is configured such that: the overshoot amount is set with reference to a first lookup table storing information of the overshoot amount.

According to the above invention, an overshoot process can be easily carried out.

In order to solve the above problems, the display device of the present invention is configured such that: the correction amount is set with reference to a second lookup table storing information on the correction amount.

According to the above invention, gray scale correction can be easily carried out.

In order to solve the above problems, the display device of the present invention is configured such that:

the second lookup table stores the information on the correction amount corresponding to a part of the positions of the respective columns; the correction amount of the gray scale correction is set for the overshoot-processed gray scale data corresponding to the part of the positions of the respective columns, by reading in the information on the correction amount stored in the second lookup table; and the correction amount is set for the overshoot-processed gray scale data corresponding to other positions of the respective columns, by obtaining the correction amount by an interpolation operation with use of the information on the correction amount stored in the second lookup table.

According to the above invention, it is possible to reduce an amount of data of information on the correction amount stored in the second lookup table. Accordingly, a size of means for carrying out the gray scale correction can be reduced.

In order to solve the above problems, a method of the present invention for driving a display device of an active matrix type, the method includes the steps of: carrying out an overshoot process on gray scale data of a target frame, the gray scale data being to be converted into a data signal, the overshoot process converting the gray scale data so that the gray scale data includes an overshoot amount in accordance with at least the gray scale data of a predetermined frame preceding the target frame and the gray scale data of the target frame; and further carrying out gray scale correction on overshoot-processed gray scale data obtained by carrying out the overshoot process on the gray scale data of the target frame, the gray scale correction being carried out by use of a correction amount corresponding to each of positions of respective columns to each of which the data signal is to be supplied, the respective columns being on a display panel.

According to the above invention, even when both an overshoot process and gray scale correction of gray scale data are carried out in which gray scale correction a correction amount has an in-plane distribution corresponding to each column position on a display panel to which a data signal is to be supplied, the overshoot process is carried out on original gray scale data of the target frame. Further, the gray scale correction is carried out on gray scale data obtained by carrying out the overshoot process on the gray scale data of a target frame. Accordingly, an overshoot amount can be set according to a conventional basis. Further, because the correction amount of the gray scale correction corresponds to each column position and can be set regardless of the overshoot amount, an substantial effective value of a voltage applied to a display element can be easily made equal to an substantial effective value in a case where the overshoot process is carried out without carrying out the gray scale correction.

This makes it possible to attain a method for driving a display device that can carry out an appropriate overshoot process in addition to gray scale correction, such as compensation of a feed through voltage, on each gray scale data to be converted into a data signal. The gray scale correction is carried out in accordance with each column position of a display panel to which the data signal is to be supplied.

In order to solve the above problems, the method of the present invention is configured such that: the correction amount corresponds to a magnitude of a feed-through voltage corresponding to each of the positions of the respective columns.

According to the above invention, in a case where the gray scale correction is a process for compensating an in-plane distribution of feed through voltage, an appropriate overshoot process can be carried out.

In order to solve the above problems, the method of the present invention is configured such that: a polarity of a data signal to be supplied to each picture element is reversed every one frame.

According to the above invention, when data of a picture element is rewritten, a polarity of a data signal is reversed. However, because an appropriate overshoot process is carried out on the gray scale data, a response speed of liquid crystals can be appropriately improved.

In order to solve the above problems, the method of the present invention is configured such that the gray scale data to be converted into the data signal is gray scale data to be supplied to a display driver.

According to the above invention, even in a case where a display driver does not have a function to carry out gray scale correction, it is possible to carry out gray scale correction in a circuit of a preceding stage such as a display controller.

In order to solve the above problems, the method of the present invention is configured such that a gate pulse is supplied to each gate bus line from each of both ends of the each gate bus line.

According to the above invention, a gate pulse is supplied from each of both sides of each gate bus line. Accordingly, a scale of a distribution in delay of the gate pulse is reduced and a scale of an in-plane distribution of a correction amount of gray scale correction for compensating an in-plane distribution of feed through voltage is reduced. Therefore, it becomes possible to carry out compensation of a feed through phenomenon while keeping a wide reproduction range for the overshoot-processed gray scale data.

In order to solve the above problems, the method of the present invention is configured such that a gate pulse is supplied to each gate bus line from one predetermined end of the each gate bus line.

According to the above invention, though a scale of an in-plane distribution of feed through voltage in each gate bus line is large, an overshoot process can appropriately be carried out without receiving an influence of the in-plane distribution. Accordingly, the above invention provides a significant effect such that no change occurs in an effect of the overshoot process from an effect in a case where the overshoot process is carried out without carrying out the gray scale correction.

In order to solve the above problems, the method of the present invention is configured such that: the overshoot amount is set with reference to a first lookup table storing information of the overshoot amount.

According to the above invention, an overshoot process can be easily carried out.

In order to solve the above problems, the method of the present invention is configured such that: the correction amount is set with reference to a second lookup table storing information on the correction amount.

According to the above invention, gray scale correction can be easily carried out.

In order to solve the above problems, the method of the present invention is configured such that: the second lookup table stores the information on the correction amount corresponding to a part of the positions of the respective columns; the correction amount is set for the overshoot-processed gray scale data corresponding to the part of the positions of the respective columns, by reading in the information on the correction amount stored in the second lookup table; and the correction amount is set for the overshoot-processed gray scale data corresponding to other positions of the respective columns, by obtaining the correction amount by an interpolation operation with use of the information on the correction amount stored in the second lookup table.

According to the above invention, it is possible to reduce an amount of data of information on the correction amount stored in the second lookup table. Accordingly, a size of means for carrying out the gray scale correction can be reduced.

### Advantageous Effects of Invention

As described above, a display device of the present invention of an active matrix type (i) carries out an overshoot process on gray scale data of a target frame, the gray scale data being to be converted into a data signal, the overshoot process converting the gray scale data so that the gray scale data includes an overshoot amount in accordance with at least the gray scale data of a predetermined frame preceding the target frame and the gray scale data of the target frame, and (ii) further carries out gray scale correction on overshoot-processed gray scale data obtained by carrying out the overshoot process on the gray scale data of the target frame, the gray scale correction being carried out by use of a correction amount corresponding to each of positions of respective columns to each of which the data signal is to be supplied, the respective columns being on a display panel.

As described above, a method of the present invention for driving a display device of an active matrix type, the method includes the steps of: carrying out an overshoot process on gray scale data of a target frame, the gray scale data being to be converted into a data signal, the overshoot process converting the gray scale data so that the gray scale data includes an overshoot amount in accordance with at least the gray scale data of a predetermined frame preceding the target frame and the gray scale data of the target frame; and further carrying out gray scale correction on overshoot-processed gray scale data obtained by carrying out the overshoot process on the gray scale data of the target frame, the gray scale correction being carried out by use of a correction amount corresponding to each of positions of respective columns to each of which the data signal is to be supplied, the respective columns being on a display panel.

This makes it possible to attain a display device that is capable of carrying out an appropriate overshoot process on each gray scale data to be converted into a data signal in addition to gray scale correction, such as compensation of a feed through voltage, in accordance with a column position on a display panel to which the data signal is to be supplied.

### BRIEF DESCRIPTION OF DRAWINGS

FIG. 1 illustrates an embodiment of the present invention and is a diagram illustrating a method for carrying out both an overshoot process and feed through voltage correction.

FIG. 2 illustrates an embodiment of the present invention and is a circuit block diagram illustrating a configuration of a display device that performs the methods of FIG. 1.

FIG. 3 is a plan view illustrating an exemplary configuration of a picture element in the display device of FIG. 2.

FIG. 4 is a block diagram illustrating a configuration of a timing controller of a display controller included in the display device of FIG. 2.

FIG. 5 illustrates a conventional technique and is a circuit diagram showing a configuration of a picture element in the form of an equivalent circuit.

FIG. 6 is a potential waveform chart illustrating a feed through phenomenon of the picture element of FIG. 5.

FIG. 7 is a potential waveform chart illustrating that the feed through phenomenon of FIG. 6 has a certain distribution within a plane of a panel.

FIG. 8 is a diagram illustrating a method for compensating an in-plane distribution of the feed through phenomenon of FIG. 7; (a) is a plan view illustrating an exemplary configuration of a panel assumed; (b) is a graph illustrating in-plane distributions of feed through voltages and picture element electrode potentials; and (c) is a graph illustrating a correction amount distribution of gray scale data used for compensating the feed through voltages.

FIG. 9 is a diagram illustrating a configuration of a lookup table used for compensation of the feed through phenomenon of FIG. 8.

FIG. 10 illustrates a conventional technique and is a diagram showing a configuration of a lookup table used for carrying out an overshoot process.

FIG. 11 illustrates a conventional technique and is diagram illustrating an overshoot process; (a) of FIG. 11 is a diagram showing a change in effective value of a voltage across a liquid crystal layer in a case where the overshoot process is carried out without carrying out compensation of a feed-through voltage; and (b) of FIG. 11 is a diagram illustrating a change in effective value of a voltage across the liquid crystal layer in a case where both compensation of a feed-through voltage and an overshoot process are carried out.

### DESCRIPTION OF EMBODIMENTS

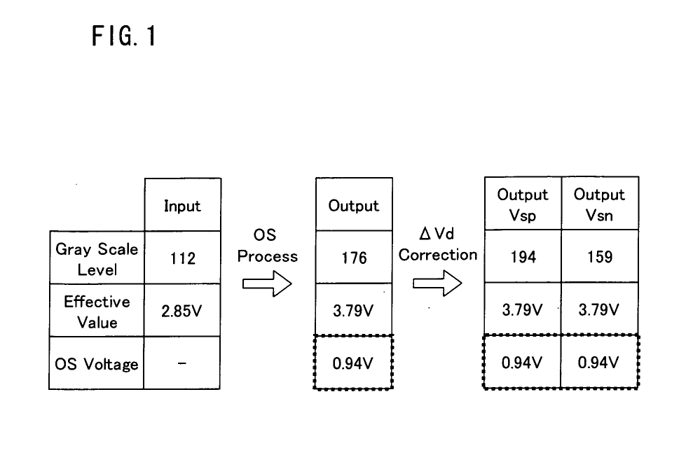

The following explains an embodiment of the present invention with reference to FIGS. 1 to 4.

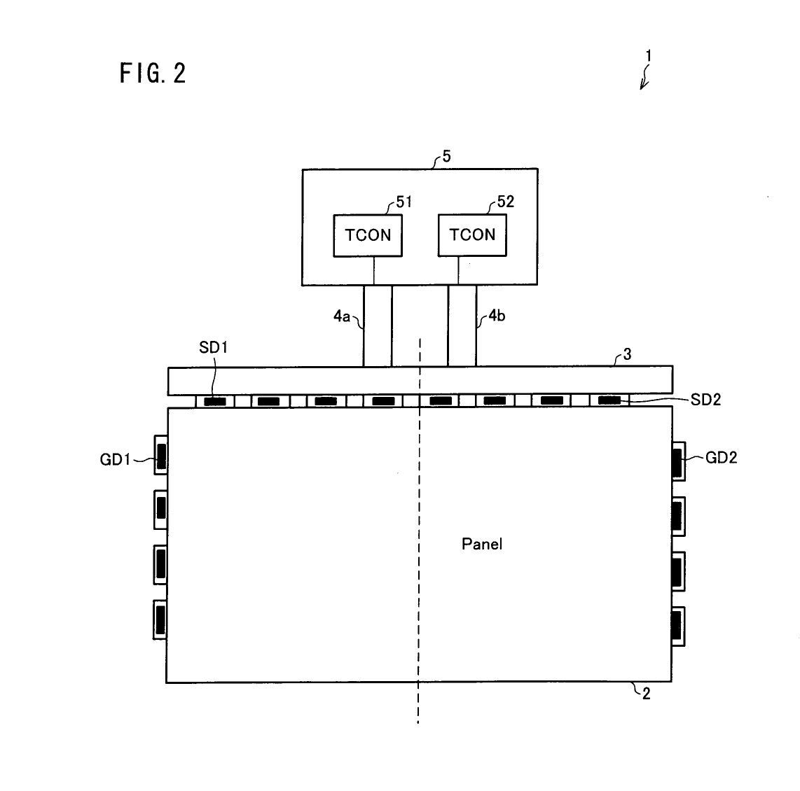

FIG. 2 illustrates a configuration of a liquid crystal display device (display device) 1 of the present embodiment. As shown in FIG. 2, the liquid crystal display device 1 is an active matrix display device including a display panel 2, an SOF board 3, a plurality of source drivers (display drivers) SD1 . . . and SD2 . . . , a plurality of gate drivers GD1 . . . and GD2 . . . , flexible wires 4a and 4b, and a display controller 5. Note that any disposition of the above members is possible. That is, any combination of the display panel 2 and other members may be mounted on one panel. Alternatively, a part or all of the plurality of source drivers SD1 . . . and SD2 . . . , the plurality of gate drivers GD1 . . . and GD2 . . . , and the display controller 5 may be mounted on an external board such as a flexible printed board and connected to a panel including the display panel 2.

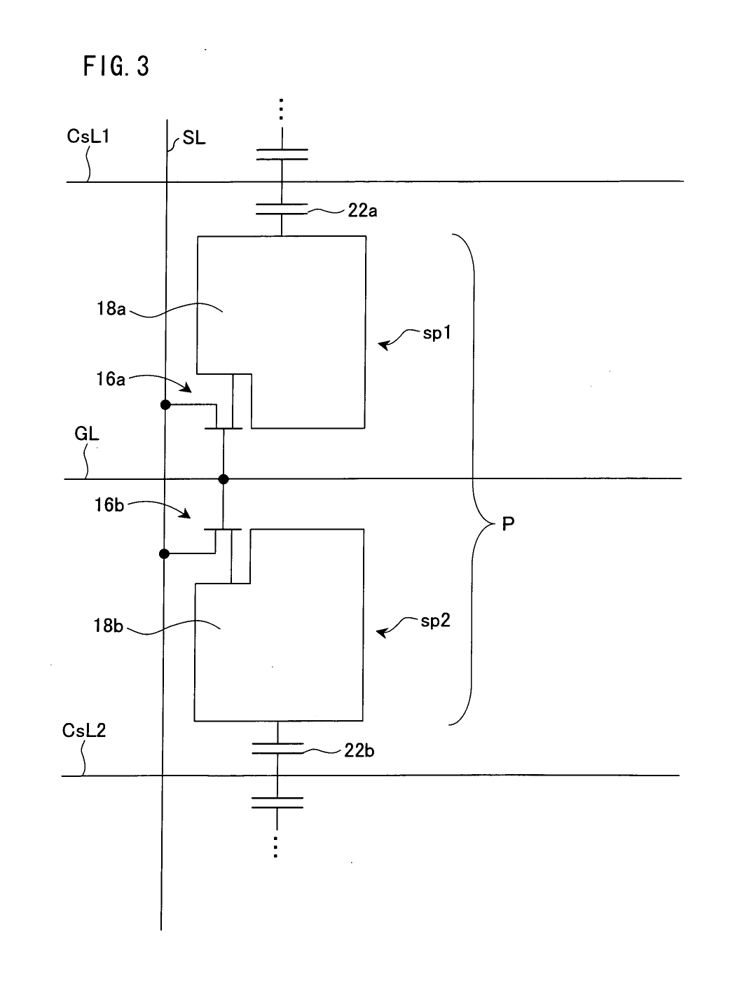

FIG. 3 shows an exemplary configuration of each picture element P provided in the display panel 2. Here, the picture element P has a picture element configuration of a multi-picture-element drive method that improves viewing angle dependency of a y characteristic in the display device. However, the configuration of the picture element is not limited to this but may adopt any configuration. In the multi-picture-element drive, one picture element is formed by two or more sub-picture elements that have different luminances, respectively. This improves a viewing angle characteristic or the viewing angle dependency of the γ characteristic.

One picture element 2 is divided into sub-picture elements sp1 and sp2. The sub-picture element sp1 includes a TFT 16a, a sub-picture element electrode 18a, and a storage capacitor 22a, and the sub-picture element sp2 includes a TFT 16b, a sub-picture element electrode 18b, and a storage capacitor 22b.

The TFTs 16a and 16b have respective gate electrodes connected to a common gate bus line GL and respective source electrodes connected to a common source bus line SL. The storage capacitance 22a is formed between the sub-picture element electrode 18a and a storage capacitor bus line CsL1, and the storage capacitor 22b is formed between the sub-picture element electrode 18b and a storage capacitor bus line CsL2. The storage capacitor bus line CsL1 is provided so that an area of the sub-picture element sp1 is between the storage capacitor bus line CsL1 and the gate bus line GL and the storage capacitor bus line CsL1 extends in parallel to the gate bus line GL. Meanwhile, the storage capacitor bus line CsL2 is provided so that an area of the sub-picture element sp2 is between the storage capacitor bus line CsL2 and the gate bus line GL and the storage capacitor bus line CsL2 extends in parallel to the gate bus line GL.

Further, the storage capacitor bus line CsL1 of each picture element P also serves as a storage capacitor bus line CsL2 that allows a sub-picture element sp2 of another picture element P that is adjacent to the picture element P via the storage capacitor bus line CsL1 to form a storage capacitor 22b. Further, the storage capacitor bus line CsL2 of each picture element P also serves as a storage capacitor bus line CsL1 that allows a sub-picture element sp1 of still another picture element P that is adjacent to the picture element P via the storage capacitor bus line CsL2 to form a storage capacitor 22a.

Both the sub-picture elements sp1 and sp2 are connected to one source bus line SL and further both the TFTs 16a and 16b are connected to one gate bus line GL. Accordingly, it is considered that the same data signals, that is, the same gray scale data is supplied to the sub-picture elements sp1 and sp2. This gray scale data corresponds to a luminance of the picture element P as a whole which luminance is obtained as a total result of contributions of the sub-picture elements sp1 and sp2.

In FIG. 2, the source drivers SD1 . . . and SD2 . . . and the gate drivers GD1 . . . and GD2 . . . are connected to the display panel 2 in the form of an SOF (System On Film) package. Here, the source drivers SD1 . . . and SD2 . . . are connected to only one side of the display panel 2. The source drivers SD1 . . . supply data signals to source bus lines SL . . . on a left half of the display panel 2 on a sheet of drawing, and the source drivers SD2 . . . supplies data signals to source bus lines SL . . . on a right half of the display panel on the sheet of drawing. To a side on a left side of the sheet of drawing which side is orthogonal to the side to which the source drivers SD1 . . . and SD2 . . . are connected, the gate drivers GD1 . . . are connected. Meanwhile, to a side on a right side of the sheet of drawing which side is orthogonal to the side to which the source drivers SD1 . . . and SD2 . . . are connected, the gate drivers GD2 . . . are connected. However, disposition of the source drivers SD1 . . . and SD2 . . . and the gate drivers GD1 . . . and GD2 . . . is not limited to the one described above. Further, the source drivers SD1 . . . and SD2 . . . are connected to the SOF board 3. To each source driver, corresponding gray scale data is supplied from the SOF board 3.

The SOF board 3 is connected to the display controller 5 via the flexible wires 4a and 4b. The flexible wires 4a includes a connecting line to the source drivers SD1 . . . and the gate drivers GD1 . . . . Meanwhile, the flexible wires 4b includes a connecting line to the source drivers SD2 . . . and the gate drivers GD2 . . . . The display controller 5 includes timing controllers 51 and 52 and supplies timing signals used by the source drivers SD1 . . . and SD2 . . . and the gate drivers GD1 . . . and GD2 . . . , gray scale data used by the source drivers SD1 . . . and SD2 . . . and storage capacitor voltages used by the storage capacitor bus lines CsL1 and CsL2. Timing signals and storage capacitor voltages used by the gate drivers GD1 . . . and GD2 . . . are supplied into the display panel 2 via the SOF board 3 and the SOF package of the source drivers SD1 . . . and SD2 . . . . Note that the timing controllers 51 and 52 may be integrated as one unit and sorting of gray scale data for supply to the left and right sides of the panel may be performed in any circuit block provided in the display controller 5.

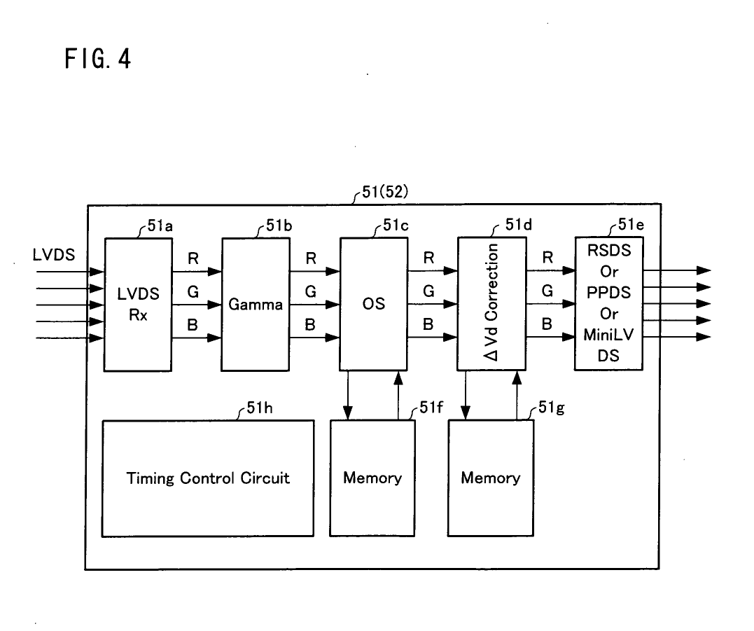

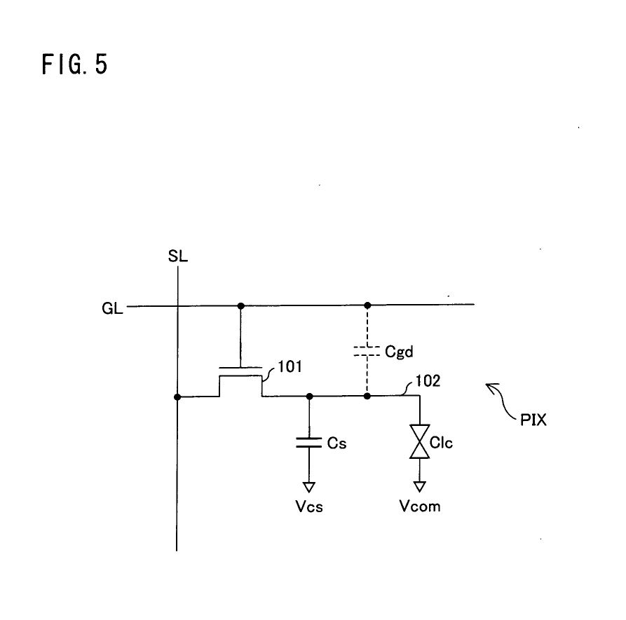

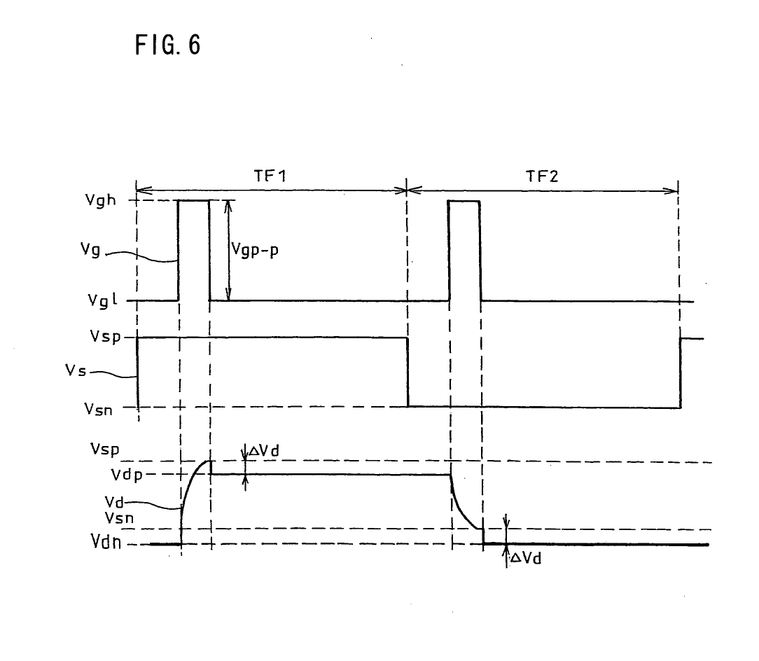

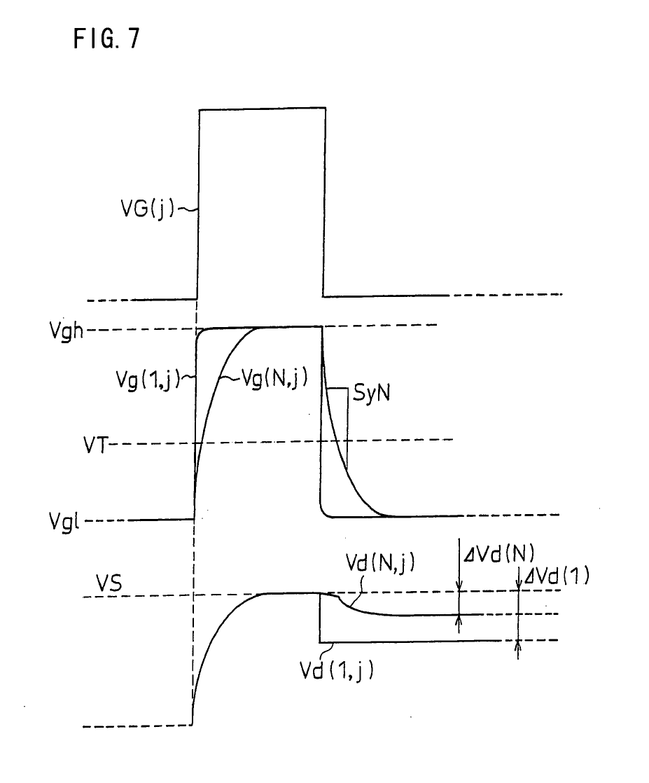

FIG. 4 shows a configuration of the timing controllers 51 and 52. The timing controllers 51 and 52 have an identical configuration. Therefore, this embodiment explains only the timing controller 51. Note that the timing controller 51 performs processing on signals, data, storage capacitor voltages and the like for the source drivers SD1 . . . and the gate drivers GD1 . . . . on the left half side of the display panel 2 on the sheet of drawing, and the timing controller 52 performs processing on signals, data, storage capacitor voltages and the like for the source drivers SD2 . . . and the gate drivers GD2 . . . on the right half side of the display panel 2 on the sheet of drawing.

The timing controller 51 includes an LVDS receiver 51a, a gamma correction section 51b, an overshoot processing section 51c, a feed-through voltage correction section 51d, a data transmission driver 51e, a memory 51f, a memory 51g, and a timing control circuit 51h.

The LDVS receiver 51a receives RGB display data outputted from an LVDS driver. The gamma correction section 51b performs gamma correction on the RGB display data received from the LVDS receiver 51a.

The overshoot processing section 51c carries out, on RGB gray scale data inputted into the overshoot processing section 51c from the gamma correction section 51b, an overshoot process in which an overshoot amount is added to the gray scale data with reference to a first lookup table stored in the memory 51f. The first lookup table stores information on the overshoot amount and the overshoot processing section 51c sets an overshoot amount by reading in the information on the overshoot amount stored in the first lookup table. The overshoot amount to be added can also be a negative value. The information on the overshoot amount may be an overshoot amount itself that is to be added to inputted gray scale data, or alternatively be gray scale data that is a result of addition of the overshoot amount in accordance with inputted gray scale data.

The ΔVd correction section 51d carries out gray scale correction in accordance with a column position to which a data signal corresponding to gray scale data is to be supplied. This gray scale correction is carried out, with reference to a second lookup table stored in the memory 51g, on gray scale data on which an overshoot process is carried out (hereinafter, also referred to as overshoot-processed gray scale data) which gray scale data is RGB gray scale data inputted into the ΔVd correction section 51d from the overshoot processing section 51c. The second lookup table stores information on a correction amount of gray scale correction corresponding to each column position. The ΔVd correction section 51d sets a correction amount of gray scale correction for the overshoot-processed gray scale data corresponding to each column position, by reading in the information on the correction amount stored in the second lookup table. The information on the correction amount may be a correction amount itself that is to be added to or subtracted from inputted overshoot-processed gray scale data, or alternatively gray scale data that is a result of addition or subtraction of the correction amount in accordance with the inputted overshoot-processed gray scale data.

The data transmission driver 51e converts RGB gray scale data that has been outputted from the ΔVd correction section 51d, into serial data suitable for transmission to the display panel 2, for example, RSDS (Reduced Swing Differential Signaling), PPDS (Point To Point Differential Signaling), or MiniLVDS. Then, the data transmission driver 51e outputs the serial data.

The timing control circuit 51h generates and outputs timing signals such as clock signals and start pulse signals that are used by the source drivers and the gate drivers.

Here, the following explains in detail processes carried out by the overshoot processing section 51c and the ΔVd correction section 51d.

It is assumed that, as shown in FIG. 1, gray scale data “112” is outputted from the gamma correction section 51b and inputted into the overshoot processing section 51c. The gray scale data “112” is assumed to be data whose substantial effective value of a voltage across the liquid crystal layer is, for example, 2.85 V.

The overshoot processing section 51c generates overshoot-processed gray scale data “176” obtained by adding an overshoot amount “64” to the input gray scale data “112”, with reference to a lookup table similar to a lookup table shown in FIG. 10. This lookup table is stored in the memory 51f as the first lookup table. When this gray scale data “176” and the original gray scale data “112” are used for writing in the picture element P, the substantial effective value becomes 3.79 V. As a result, the substantial effective value is boosted by 0.94 V by the overshot drive.

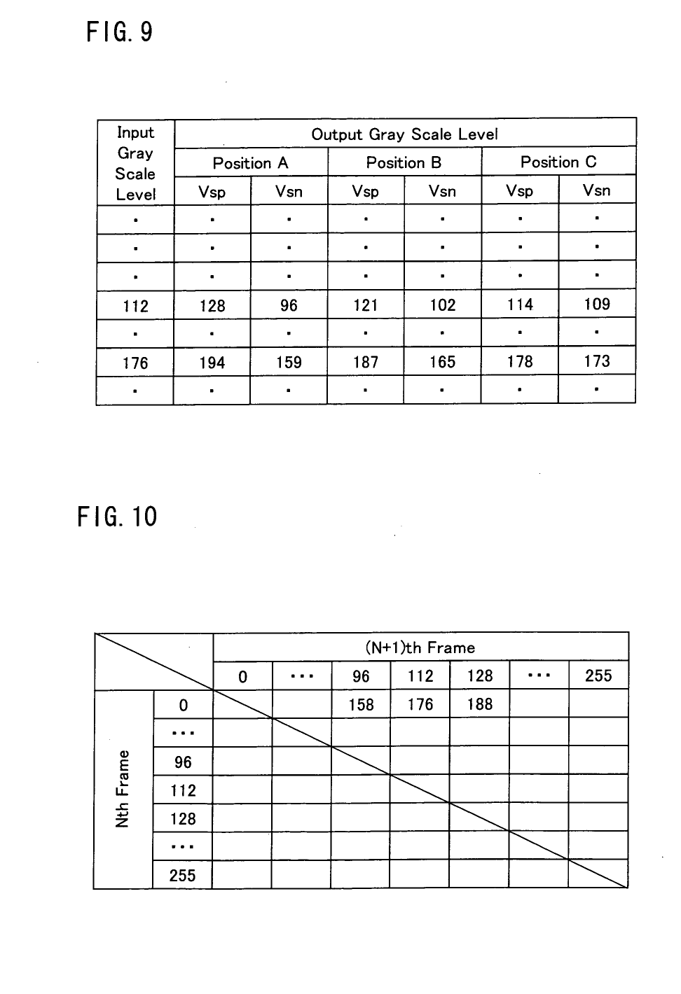

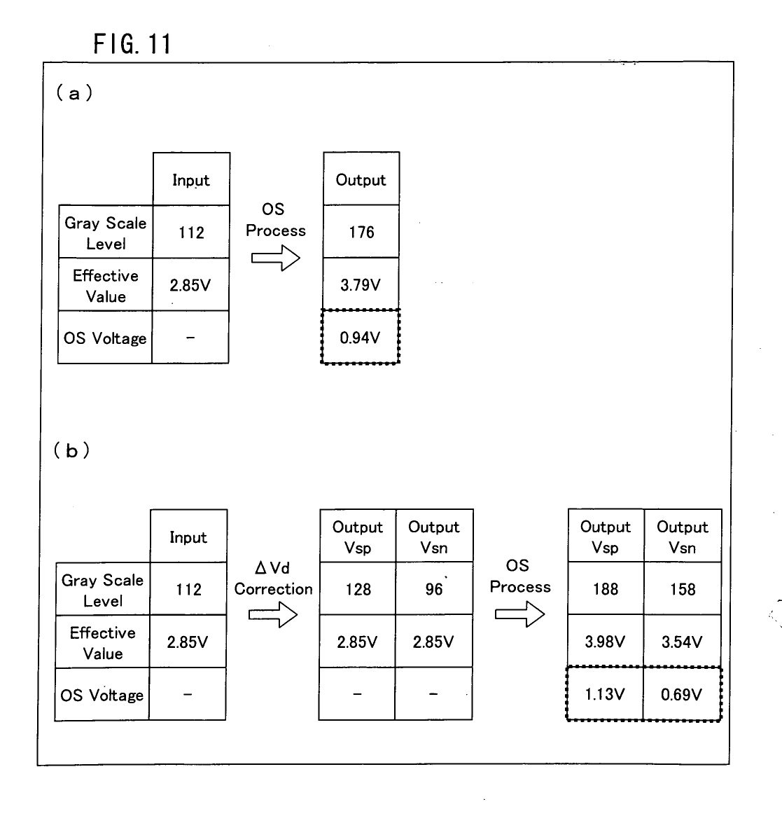

The overshoot-processed gray scale data “176” obtained by the overshoot process carried out by the overshoot processing section 51c is inputted into the ΔVd correction section 51d. Then, in the case of an example where a column of a given position (panel end sections A of FIG. 9) is taken as an example, thus inputted overshoot-processed gray scale data “176” is corrected to gray scale data “194” by adding a correction amount “18” in a case where a polarity is positive. Meanwhile, in a case where the polarity is negative, the gray scale data “176” is corrected to gray scale data “159” by subtracting a correction amount “17”. Both of the gray scale data “194” and the gray scale data “159” are data whose substantial effective values are the same as those before the correction, that is, 3.79 V, in consideration of the occurrence of the feed-through phenomenon. Accordingly, the effect of the overshoot drive can be maintained as it is.

As described above, according to the liquid crystal display device 1 of the present embodiment, the display controller 5 carries out an overshoot process on gray scale data of a target frame which gray scale data is to be supplied to source drivers SD1 . . . and SD2 . . . . In the overshoot process, data is converted so that such gray scale data includes an overshoot amount at least in accordance with the gray scale data of a predetermined frame that precedes the target frame and the gray scale data of the target frame. Further, the display controller 5 carries out gray scale correction on overshoot-processed gray scale data obtained as a result of the overshoot process on the gray scale data of the target frame. This gray scale correction is carried out by use of a correction amount corresponding to each column position on the display panel 2 to which column position a data signal is to be supplied. The overshoot amount may be determined in accordance with gray scale data of a target frame and gray scale data of a predetermined frame preceding the target frame, for example, a frame immediately preceding the target frame, or alternatively in accordance with gray scale data of a predetermined frame preceding a target frame, gray scale data of the target frame, and gray scale data of a predetermined frame succeeding the target frame.

According to the above configuration, even when both the overshoot process and the compensation of the voltage ΔVd in consideration of an in-panel distribution are carried out, the overshoot process is carried out with respect to original gray scale data and the compensation of the voltage ΔVd is carried out with respect to the overshoot-processed gray scale data. Accordingly, the overshoot amount can be set according to the same basis as that in a conventional configuration. Further, the correction amount of gray scale correction for compensating the voltage ΔVd can be set regardless of the overshoot amount. Therefore, an substantial effective value of a voltage applied to liquid crystals that form display elements can be arranged to be an appropriate value as in a case where the overshoot process is carried out without compensation of the voltage ΔVd. As a result, while a feed-through voltage is compensated, an appropriate overshoot drive can be carried out.

Note that in the above example, the gray scale correction is carried out with respect to an in-plane distribution of the voltage ΔVd. However, the present invention is not limited to this but is generally applicable to a process in which gray scale correction is carried out by a correction amount in accordance with each column position. This is easily understood from the fact that the correction amount of this gray scale correction corresponds to each column position and is irrelevant to a set overshoot amount. Accordingly, the gray scale correction may be gray scale correction that keeps an effective value of the voltage across the liquid crystal layer constant before and after the correction or may alternatively be gray scale correction that does not keep an effective value of the voltage across the liquid crystal layer before and after the correction. Further, because the correction amount is a function of the column position, it is easily understood that there may be a position where gray scale data is not changed. Therefore, the correction amount can be “0”. In addition, positive and negative signs of the correction amount can be determined as appropriate according to a position.

Moreover, in a case where the liquid crystal display device 1 carries out AC drive in which a polarity of a data signal to be supplied to each picture element is reversed every one frame, the polarity of the data signal is reversed when data of a picture element is rewritten. However, because an appropriate overshoot process is carried out on gray scale data, a response speed of liquid crystals can be appropriately improved.

Further, as shown in FIG. 2, when the liquid crystal display device 1 is to supply a gate pulse from each of both sides of each gate bus line GL into each gate bus line GL, there occurs a decrease in unevenness of the gate pulse delay distribution. This achieves a decrease in unevenness of an in-plane distribution of the gray scale correction amount for correcting the in-plane distribution of the voltage ΔVd. Therefore, it is possible to compensate a feed-through phenomenon while ensuring a wide reproduction range for the overshoot-processed gray scale data.

Further, though not shown, in a case where in the liquid crystal display device, a gate pulse is supplied to each gate bus line from a predetermined one end of each gate bus line, there occurs an in-plane distribution with large unevenness of the feed-through voltage in each gate bus line GL. However, in the present invention, the overshoot process can be performed appropriately while the overshoot process is not influenced by this in-plane distribution. Accordingly, the present invention has a significant effect such that an effect of the overshoot process is not changed from a case where the overshoot process is performed without performing the gray scale correction.

Further, the liquid crystal display device 1 sets an overshoot amount by reading in the overshoot amount from the first lookup table that stores information on the overshoot amount. Therefore, the overshoot process can be easily carried out.

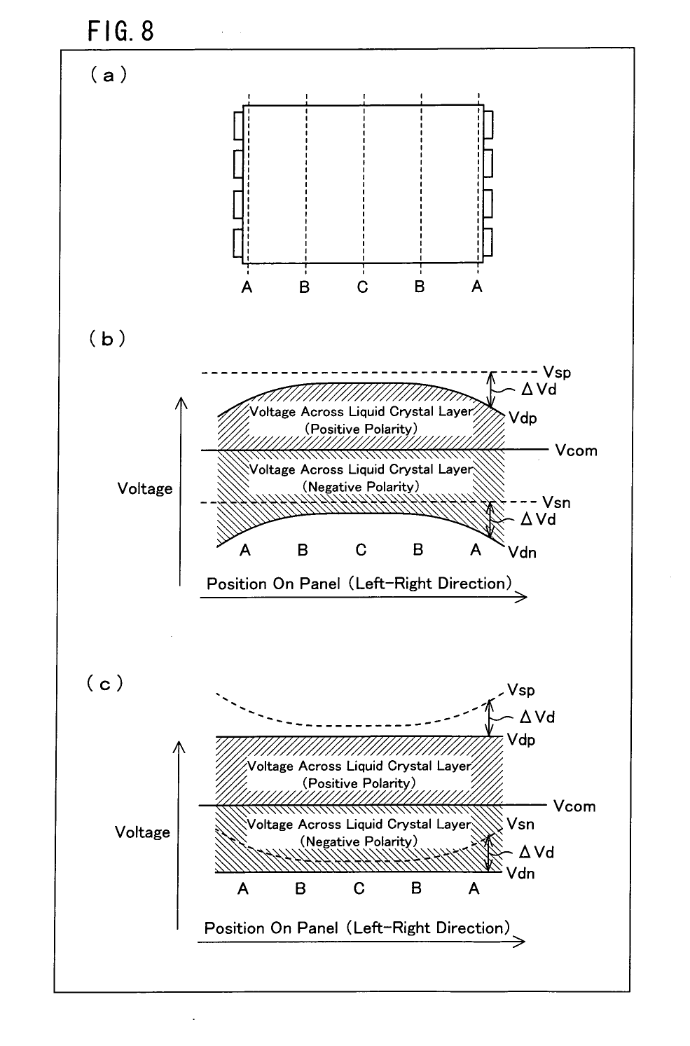

Note that the liquid crystal display device 1 may be configured such that: information on a correction amount of gray scale correction in accordance with a position of a part of columns as shown in (a) to (c) of FIG. 8 is stored in the second lookup table; a correction amount of gray scale correction is set for overshoot-processed gray scale data corresponding to the position of the part of columns, by using information on the correction amount which information is stored in the second lookup table; and a correction amount of the gray scale correction is set for overshoot-processed gray scale data corresponding to positions of other columns, by obtaining a correction amount of the gray scale correction by an interpolation operation such as linear interpolation using information on the correction amount stored in the second lookup table. This makes it possible to reduce an amount of data of correction amounts stored in the second lookup table. Consequently, it becomes possible to reduce a size of means for carrying out the gray scale correction.

Note that the above example explains a configuration where: the overshoot process is carried out on gray scale data to be supplied to the display driver; and the gray scale correction is further carried out before the overshoot-processed gray scale data is supplied to the display driver. However, the present invention may be configured such that a data signal line driver has a function to carry out the gray scale correction or the data signal line driver has functions of the overshoot process and the gray scale correction, as long as the overshoot process is carried out on gray scale data that is to be converted into a data signal and further the gray scale correction is carried out on the gray scale data.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is suitably applied to various display devices including liquid crystal display devices.

### REFERENCE SIGNS LIST

1 liquid crystal display device (display device)
2 display panel
5 display controller
51c overshoot processing section
51d ΔVd correction section
GL gate bus line
SL source bus line
SD1, SD2 source driver (display driver)
PIX picture element
Vcom common electrode potential

1. A display device of an active matrix type (i) carrying out an overshoot process on gray scale data of a target frame, the gray scale data being to be converted into a data signal, the overshoot process converting the gray scale data so that the gray scale data includes an overshoot amount in accordance with at least the gray scale data of a predetermined frame preceding the target frame and the gray scale data of the target frame, and (ii) further carrying out gray scale correction on overshoot-processed gray scale data obtained by carrying out the overshoot process on the gray scale data of the target frame, the gray scale correction being carried out by use of a correction amount corresponding to each of positions of respective columns to each of which the data signal is to be supplied, the respective columns being on a display panel.

2. The display device as set forth in claim 1, wherein:
the correction amount corresponds to a magnitude of a feed-through voltage corresponding to each of the positions of the respective columns.

3. The display device as set forth in claim 1, wherein:
a polarity of a data signal to be supplied to each picture element is reversed every one frame.

4. The display device as set forth in claim 1, wherein the gray scale data to be converted into the data signal is gray scale data to be supplied to a display driver.

5. The display device as set forth in claim 1, wherein a gate pulse is supplied to each gate bus line from each of both ends of the each gate bus line.

6. The display device as set forth in claim 1, wherein a gate pulse is supplied to each gate bus line from one predetermined end of the each gate bus line.

7. The display device as set forth in claim 1, wherein:
the overshoot amount is set with reference to a first lookup table storing information of the overshoot amount.

8. The display device as set forth in claim 1, wherein:
the correction amount is set with reference to a second lookup table storing information on the correction amount.

9. The display device as set forth in claim 8, wherein:
the second lookup table stores the information on the correction amount corresponding to a part of the positions of the respective columns;
the correction amount is set for the overshoot-processed gray scale data corresponding to the part of the positions of the respective columns, by reading in the information on the correction amount stored in the second lookup table; and
the correction amount is set for the overshoot-processed gray scale data corresponding to other positions of the respective columns, by obtaining the correction amount by an interpolation operation with use of the information on the correction amount stored in the second lookup table.

10. A method for driving a display device of an active matrix type, the method comprising the steps of:
carrying out an overshoot process on gray scale data of a target frame, the gray scale data being to be converted into a data signal, the overshoot process converting the gray scale data so that the gray scale data includes an overshoot amount in accordance with at least the gray scale data of a predetermined frame preceding the target frame and the gray scale data of the target frame; and
further carrying out gray scale correction on overshoot-processed gray scale data obtained by carrying out the overshoot process on the gray scale data of the target frame, the gray scale correction being carried out by use of a correction amount corresponding to each of positions of respective columns to each of which the data signal is to be supplied, the respective columns being on a display panel.

11. The method as set forth in claim 10, wherein:
the correction amount corresponds to a magnitude of a feed-through voltage corresponding to each of the positions of the respective columns.

12. The method as set forth in claim 10, wherein:
a polarity of a data signal to be supplied to each picture, element is reversed every one frame.

13. The method as set forth in claim 10, wherein the gray scale data to be converted into the data signal is gray scale data to be supplied to a display driver.

14. The method as set forth in claim 10, wherein a gate pulse is supplied to each gate bus line from each of both ends of the each gate bus line.

15. The method as set forth in claim 10, wherein a gate pulse is supplied to each gate bus line from one predetermined end of the each gate bus line.

16. The method as set forth in claim 10, wherein:
the overshoot amount is set with reference to a first lookup table storing information of the overshoot amount.

17. The method as set forth in claim 10, wherein:
the correction amount is set with reference to a second lookup table storing information on the correction amount.

18. The method as set forth in claim 17, wherein:
the second lookup table stores the information on the correction amount corresponding to a part of the positions of the respective columns;
the correction amount is set for the overshoot-processed gray scale data corresponding to the part of the positions of the respective columns, by reading in the information on the correction amount stored in the second lookup table; and
the correction amount is set for the overshoot-processed gray scale data corresponding to other positions of the respective columns, by obtaining the correction amount by an interpolation operation with use of the information on the correction amount stored in the second lookup table.
